(19) United States
(12) Patent Application Publication
(10) Pub. No.: US 2025/0170970 A1
(43) Pub. Date: May 29, 2025

(54) NOISE INSULATION STRUCTURE OF VEHICLE FRAME

(71) Applicant: MAZDA MOTOR CORPORATION, Hiroshima (JP)

(72) Inventors: Eiji MURASAWA, Aki-gun (JP); Naoko YOROZU, Aki-gun (JP); Hidetoshi YAMAMOTO, Aki-gun (JP); Akihiro KATSUMOTO, Aki-gun (JP); Kunio KATSUTA, Aki-gun (JP)

(73) Assignee: MAZDA MOTOR CORPORATION, Hiroshima (JP)

(21) Appl. No.: 18/888,597

(22) Filed: Sep. 18, 2024

(30) Foreign Application Priority Data
Nov. 24, 2023 (JP) 2023-198965

(51) Int. Cl. B60R 13/08; B62D 25/02

(52) U.S. Cl. CPC B60R 13/083; B62D 25/025

(57) ABSTRACT

A noise insulation structure of a vehicle frame comprises a side sill, a pillar reinforcement having a lower-end portion joined to the side sill and a closed-cross section, a vertical wall portion extending upward from an upper-face portion of the side sill, and a noise insulating plate provided to be separated upward from the upper-face portion of the side sill and forming a space portion extending in a vertical direction together with the upper-face portion, the vertical wall portion, and the pillar reinforcement. An opening portion is formed at an inside portion of the upper-face portion which is positioned inside the space portion such that it penetrates the upper-face portion. An opening ratio of an opening area of the opening portion to an area of the inside portion of the upper-face portion is set to be 0.2 or less.

### BACKGROUND OF THE INVENTION

The present invention relates to a noise insulation structure of a vehicle frame.

Conventionally, a structure in which a noise insulation plate is provided inside a hollow structural member of a vehicle frame in order to insulate a traveling noise transmitted through a frame which forms a vehicle body of a vehicle, such as an automobile, (hereafter, referred to as a “vehicle frame”) is known.

In a vehicle-body structure disclosed in Japanese Patent Laid-Open Publication No. 2006-007941, for example, plural noise insulating plates are provided inside a side sill extending in a vehicle longitudinal direction of the vehicle body or a pillar reinforcement joined to an upper face of the side sill and extending in a vertical direction of the vehicle body such that they partition an inside space of the side sill or the pillar reinforcement.

In the above-described structure, however, since the noise-insulation performance is attained only at a position where the insulating plates are provided in the vehicle frame, the noise-insulation performance attained for a weight increase caused by providing the insulating plate cannot be improved sufficiently.

Meanwhile, there is also a structure in which an opening hole through which an electrodeposition liquid, such as a rust preventive agent, flows to an inside or outside of the side sill is formed at an upper-face portion of the side sill at a joint portion of two structural members forming the vehicle frame, such as at a joint portion of the side sill and the pillar reinforcement extending upward from the side sill. According to this structure, while the noise is easily transmitted to the pillar reinforcement from the side sill through the opening portion formed at the upper-face portion of the side sill, this opening portion may not be eliminated easily for allowing the electrodeposition liquid to flow to the inside or outside of the side sill therethrough. Therefore, it has been needed to further improve the noise-insulation performance around the joint portion with the opening portion.

Moreover, a design style for providing the vehicle frame in which a high strength is obtained by a thin structure has been recently developed. In the side sill designed by this style, not only the noise transmitted to the pillar reinforcement through the opening portion for the electrodeposition liquid or the like at the upper-face portion of the side sill but a transmitted noise passing through the upper-face portion of the side sill (so-called panel passing noise) may affect the vehicle silence greatly. Therefore, it is necessary to improve the noise-insulation performance of a whole part of the structure of the vehicle frame.

### SUMMARY OF THE INVENTION

The present invention has been devised in view of the above-described matters, and an object of the present invention is to provide a noise insulation structure of a vehicle frame which can properly improve the noise-insulation performance, forming the opening portion at the upper-face portion of the side sill.

The present invention is a noise insulation structure of a vehicle frame, comprising a side sill arranged at a vehicle outside-end portion of a cabin floor portion of a vehicle and having a closed-cross section extending in a vehicle longitudinal direction and an upper-face portion forming an upper face of the closed-cross section, a pillar reinforcement having a lower-end portion joined to the side sill and a closed-cross section extending in a vertical direction above the upper-face portion of the side sill, a vertical wall portion extending upward from the upper-face portion of the side sill, and a noise insulating plate provided to be separated upward from the upper-face portion of the side sill and forming a space portion extending in the vertical direction together with the upper-face portion of the side sill, the vertical wall portion, and the pillar reinforcement, wherein an opening portion is formed at an inside portion of the upper-face portion of the side sill which is positioned inside the space portion such that the opening portion penetrates the upper-face portion, and an opening ratio of an opening area of the opening portion to an area of the inside portion of the upper-face portion is set to be 0.2 or less.

The present invention is characterized by using the noise-insulation performance of a double wall constituted by the noise insulating plate and the upper-face portion of the side sill in order to improve the noise-insulation performance for the traveling noise inside the side sill, forming the opening portion at the upper-face portion of the side sill.

That is, since the opening ratio of the opening portion of the upper-face portion of the side sill is set to be 0.2 or less in the present invention, the noise passing through the upper-face portion of the side sill becomes more dominant than the noise coming into the space portion through the opening portion regarding the traveling noise transmitted to the inside of the side sill, as specifically described later. Accordingly, the noise-insulation performance of the double wall can be sufficiently obtained by the noise insulating plate and the upper-face portion of the side sill. Therefore, the noise-insulation performance can be improved properly by providing the fewer number of noise insulating plates, forming the holes at the upper-face portion of the side sill.

Herein, in the present invention, the noise-insulation performance of the double wall means that the two walls are provided to be separated from each other and the total mass of the two walls and the elasticity of an air layer formed therebetween are so used that the high noise-insulation performance can be obtained compared to a case where a single wall having the same total mass as the two walls.

In the above-described noise insulation structure of the vehicle frame, it is preferable that the opening ratio is set to be 0.003 or more.

According to this structure, a liquid, such as the rust preventive agent, can be made to properly flow to the inside or the outside of the side sill through the opening portion in vehicle manufacturing.

In the above-described noise insulation structure of the vehicle frame, it is preferable that the noise insulating plate comprises a plate-shaped base material and a sound (noise) absorbing material arranged at a periphery of the base material and having a sound-absorption performance, and the sound (noise) absorbing material is configured to close a gap between the pillar reinforcement and the base material of the noise insulating plate and a gap between the vertical wall portion and the base material of the noise insulating plate.

According to this structure, the noise insulation can be attained securely by closing the gap between the pillar reinforcement and the base material and the gap between the vertical wall portion and the base material with the sound absorbing material.

In the above-described noise insulation structure of the vehicle frame, it is preferable that the opening portion is an electrodeposition-liquid flowing hole, through which an electrodeposition liquid flows to an inside or outside of the side sill, and the electrodeposition-liquid flowing hole is constituted by plural holes which are formed at the inside portion of the upper face portion of the side sill such that the plural holes are separated from each other.

According to this structure, the electrodeposition liquid, such as the rust preventive agent, can be made to properly flow to the inside or the outside of the side sill through the opening portion.

In the above-described noise insulation structure of the vehicle frame, it is preferable that a height ratio of height of the noise insulating plate from the upper face of the side sill to height of an upper end of the vertical wall portion from the upper face of the side sill is set to be 0.2 or more or 1 or less.

According to this structure, the grade of the noise-insulation quantity can be improved more than a case where the height ratio is less than 0.2, thereby improving the noise-insulation performance securely.

In the above-described noise insulation structure of the vehicle frame, it is preferable that the height ratio is set to be 0.4 or more.

According to this structure, the noise-insulation quantity which exceeds a range of the high grade of the noise-insulation quantity in a case where the height ratio is 0.2-0.4 can be obtained, thereby improving the noise-insulation performance more.

In the above-described noise insulation structure of the vehicle frame, it is preferable that the side sill comprises a side sill outer and a side sill inner positioned on an inward side, in a vehicle width direction, of the side sill outer, each of the side sill outer and the side sill inner extends in the vehicle longitudinal direction and has a hat-shaped cross section with a pair of flange portions provided at each upper-end portion and lower-end portion, the side sill is formed by joining the respective flange portions of the side sill outer and the side sill inner, and the vertical wall portion is formed by the flange portions upward protruding of the side sill outer and the side sill inner.

According to this structure, the conventional side sill comprising the side sill outer and the side sill inner which have the hat-shaped cross section, respectively, is applicable. Therefore, this noise insulation structure can have the high versatility and low manufacturing costs.

As described above, the noise insulation structure of the vehicle frame of the present invention can properly improve the noise-insulation performance, forming the opening portion at the upper-face portion of the side sill.

The present invention will become apparent from the following description which refers to the accompanying drawings.

### BRIEF DESCRIPTION OF THE DRAWINGS

FIG. 1 is an elevational view showing main structural elements of a vehicle body to which a noise insulation structure of a vehicle frame according to an embodiment of the present invention is applied.

FIG. 2 is a sectional view taken along line II-II of FIG. 1.

FIG. 3 is a sectional view taken along line III-III of FIG. 1.

FIG. 4 is an explanatory diagram of a cross section of an exemplified noise insulating plate shown in FIG. 2, which comprises a base material and a foaming agent.

FIGS. 5A-5C are explanatory diagrams of the cross section showing attaching steps of the noise insulating plate of FIG. 4.

FIGS. 6A-6C are enlarged plan views showing attaching steps of the noise insulating plate of FIG. 4, FIG. 6A being the enlarged plan view around an opening portion of an upper-face portion of a side sill in a state before the noise insulating is attached; FIG. 6B being the enlarged plan view showing a state just after the noise insulating plate of FIG. 4 is attached and before the foaming agent foams; and FIG. 6C being the enlarged plan view showing a state after the foaming agent of the noise insulating plate foams.

FIGS. 7A-7D are graphs showing a change of the noise-reduction quantity for an opening ratio regarding four types of structural models: FIG. 7A showing that regarding a single-layered structure with no hole S1; FIG. 7B showing that regarding a single-layered structure with a hole S; FIG. 7C showing that regarding multiple-layered structure with no hole S3; and FIG. 7D showing that regarding multiple-layered structure with a hole S4.

FIGS. 8A-8C are schematically-shown models of the noise insulating plate of the present embodiment, in which height h of the foaming agent from a plate with an opening portion is changed within a range of flange height H: FIG. 8A showing a case of h=0; FIG. 8B showing a case of 0<h<H; and FIG. 8C showing a case of h=H.

FIG. 9 is a graph showing a relationship between a height ratio h/H and the noise-reduction quantity.

FIG. 10 is bar graphs showing respective sound (noise) pressures in a noise insulation structure shown in FIG. 11 as a comparative example and the noise insulation structure of the present embodiment, in which (I) relates to a position of a pillar inside, (II) relates to a position near a pillar trim, and (III) relates to a position corresponding to an ear of a passenger in a vehicle.

FIG. 11 is a sectional view showing the conventional noise insulation structure as the comparative example of the present invention, in which the foaming agent closes the opening portion of the upper-face portion of the side sill.

FIG. 12 is an enlarged view showing the conventional noise insulation structure in a state where the foaming agent closes the opening portion and an inner peripheral face of a pillar reinforcement at a surface of the upper-face portion of the side sill.

### DETAILED DESCRIPTION OF THE INVENTION

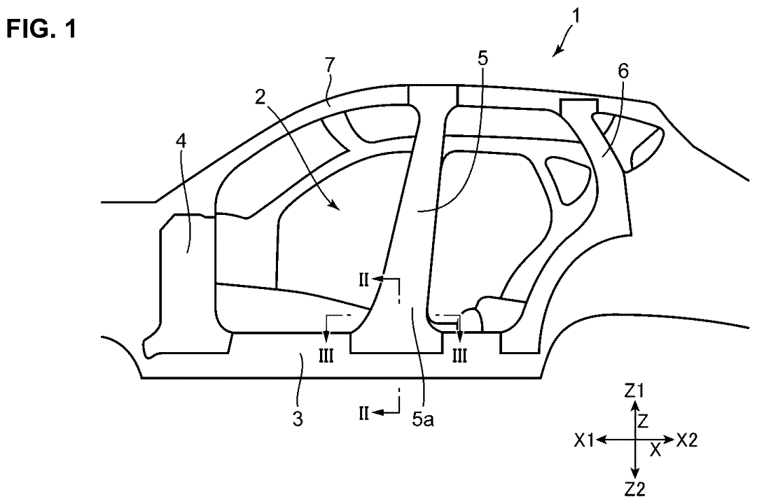

FIG. 1 is an elevational view showing main structural elements of a vehicle body 1 to which a noise insulation structure of a vehicle frame according to the embodiment of the present invention is applied.

The vehicle body 1 comprises, at both sides, in a vehicle width direction, thereof, a side sill 3 extending in a vehicle longitudinal direction X, a front pillar 4 (A pillar) extending upward Z1 from an end portion at a forward side X1, in the vehicle longitudinal direction, of the side sill 3, a center pillar 5 (B pillar) extending upward Z1 from a middle position, in the vehicle longitudinal direction X, of the side sill 3, a rear pillar 6 (C pillar) extending upward Z1 from around an end portion at a rearward side X2, in the vehicle longitudinal direction, of the side sill 3, and a roof rail 7 extending in the vehicle longitudinal direction X and interconnecting respective upper-end portions of the three pillars 4-6. Each side-end part, in the vehicle width direction, of the vehicle frame is constituted by the side sill 3, the three pillars 4-6, and the roof rail 7.

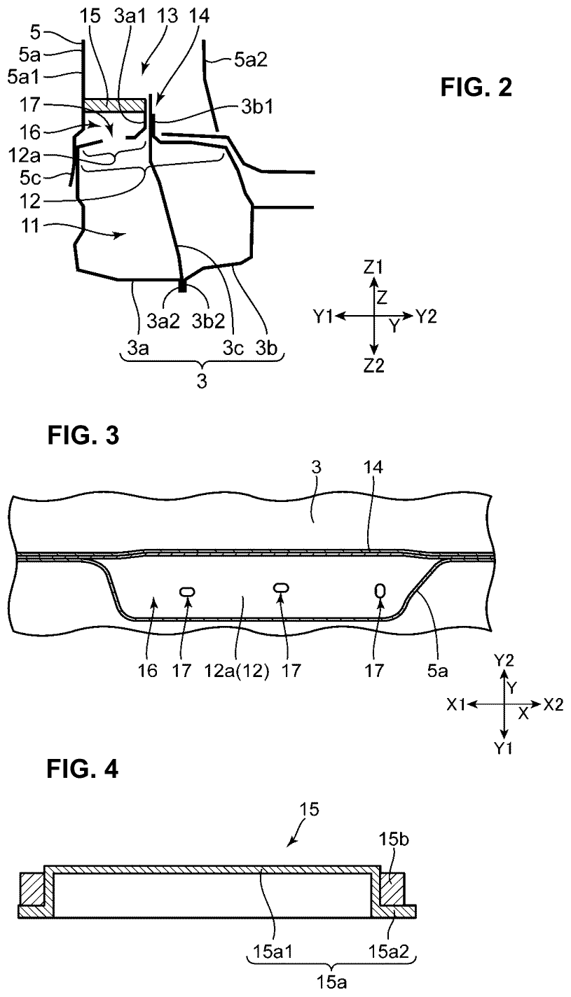

The noise insulation structure of the present embodiment is arranged at near a joint portion of the side sill 3 and a lower-end portion of the center pillar 5 in the above-described vehicle body 1 as shown in FIG. 2.

The side sill 3 is a hollow member which is arranged at a vehicle-outward end portion of a floor portion of a cabin 2 of the vehicle and extends in the vehicle longitudinal direction X. Specifically, as shown in FIG. 2, the side sill 3 comprises a side sill outer 3a, a side sill inner 3b positioned on an inward side Y2, in the vehicle width direction, of the side sill outer 3a, and a reinforcing plate 3c provided between the side sill outer 3a and the side sill inner 3b.

The side sill outer 3a has a hat-shaped cross section which extends in the vehicle longitudinal direction X and has a pair of flange portions 3a1, 3a2 at its upper-and-lower end portions. Likewise, the side sill inner 3b has a hat-shaped cross section which extends in the vehicle longitudinal direction X and has a pair of flange portions 3b1, 3b2 at its upper-and-lower end portions.

The side sill 3 is configured to have a hollow closed-cross section 11 by joining the upper-and-lower flange portions 3a1, 3a2 of the side sill outer 3a and the upper-and-lower flange portions 3b1, 3b2 of the side sill inner 3b, respectively. Further, the side sill 3 has an upper-face portion 12 which forms an upper face of the closed-cross section 11. An opening portion 17 (see FIGS. 2 and 3), which will be specifically described later, is formed at the upper-face portion 12.

The vertical wall portion 14 extends upward Z1 from the upper-face portion 12 of the side sill 3. The vertical wall portion 14 of the present embodiment is constituted by joining the respective upward-protruding flange portions 3a1, 3b1 of the side sill outer 3a and the side sill inner 3b.

The reinforcing plate 3c is configured such that its upper-end portion is interposed between the two upper flange portions 3a1, 3b1 and its lower-end portion is interposed between the two lower flange portions 3a2, 3b2, thereby reinforcing the closed-cross section 11 of the side sill 3 from inside so as to suppress deformation of the closed-cross section 11. Herein, while the side sill 3 of the present embodiment has the reinforcing plate 3c, this reinforcing plate may be omitted.

The center pillar 5 comprises a pillar reinforcement 5a and an outer panel (not illustrated) which covers an outward side Y1, in the vehicle width direction, of the pillar reinforcement 5a.

As shown in FIG. 2, the pillar reinforcement 5a is a member extending in a vertical direction Z. A lower-end portion 5c of the pillar reinforcement 5a is joined to the side sill 3. The pillar reinforcement 5a has a closed-cross section 13 which extends in the vertical direction Z on the upward side Z1 of the upper-face portion 12 of the side sill 3. In the present embodiment, the pillar reinforcement 5a is configured to have the closed-cross section 13 by integrating a pillar reinforcement outer 5a1 and an inner panel 5a2 positioned on the inward side Y2, in the vehicle width direction, of the pillar reinforcement outer 5a1 which are joined together.

The noise insulating plate 15 is provided to be separated upward Z1 from the upper-face portion 12 of the side sill 3. Accordingly, the noise insulating plate 15 forms a space portion 16 (see FIGS. 2 and 3) extending in the vertical direction Z together with the upper-face portion 12, the vertical wall portion 14, and the pillar reinforcement 5a. Therefore, noise which has been generated inside the side sill 3 in vehicle traveling can be suppressed from being transmitted upward Z1 inside the pillar reinforcement 5a, passing through the noise insulating plate 15, due to the noise-insulation performance of the double wall which is achieved by the upper-face portion 12 of the side sill 3 and the noise insulting plate 15 and also the space portion 16 enclosed by these.

Any structure or material are applicable to the noise insulating plate 15 as long as the noise insulating plate 15 is configured such that the upper end of the space portion 16 is closed and thereby the noise transmission upward from the space portion 16 is shut out or suppressed.

Specifically, as shown in FIGS. 4-6, the noise insulating plate 15 of the present embodiment comprises a base material 15a which is large enough to close the upper end of the space portion 16 and a sound absorbing material 15b, such as a foaming agent, which is arranged at a peripheral edge of the base material 15a and has the noise-absorption performance.

The base material 15a comprises a plate-shaped body portion 15a1 and a ring-shaped flange portion 15a2 which surrounds the body portion 15a1 at a one-step downward position below an outer peripheral edge of the body portion 15a1.

The sound absorbing material 15b, which is made of the foaming agent having the sound absorption performance, is arranged on the ring-shaped flange portion 15a2 over its whole periphery. Herein, any other material with the sound absorption performance than the foaming agent is usable, e.g., a resilient material of rubber or the like.

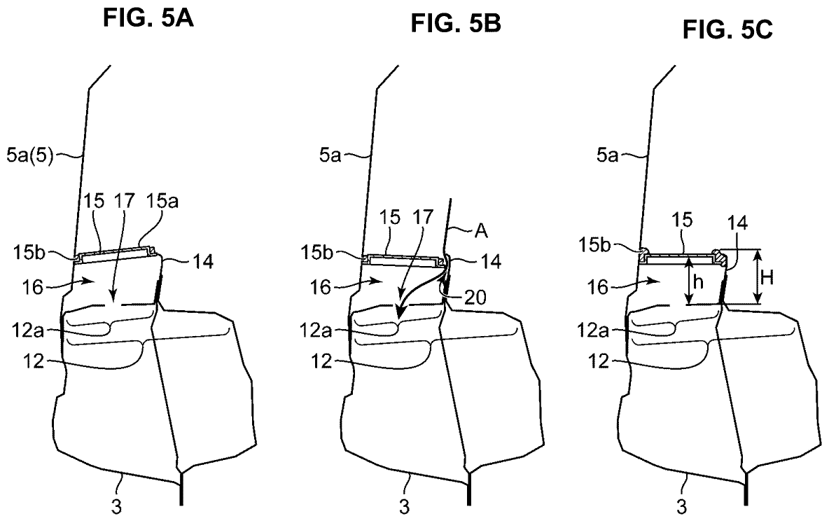

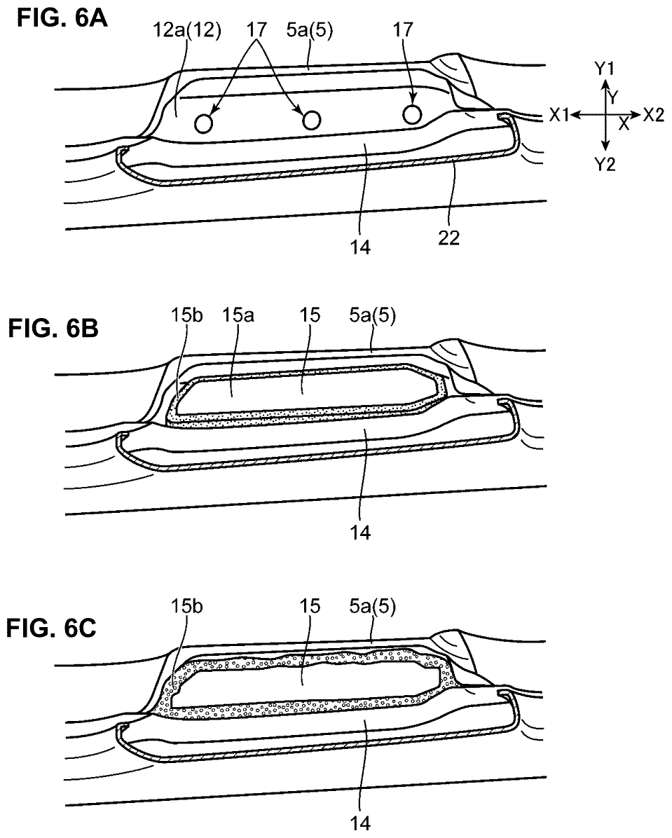

As shown in FIGS. 5A-5C, 6B and 6C, the sound absorbing material 15b made of the foaming agent of the present embodiment is configured to close a gap between the pillar reinforcement 5a and the base material 15a and another gap between the vertical wall portion 14 and the base material 15a in a state where the noise absorbing plate 15 is provided to be separated upward Z1 from the upper-face portion 12 of the side sill 3. The foaming agent is configured such that its volume expands by receiving heat when the vehicle body 1 is heated for drying the electrodeposition liquid, which will be specifically described later, so that the above-described gaps can be closed by means of the volume's expansion of the foaming agent.

Herein, any type of structure is applicable to the noise insulating plate 15 as long as it has a structure capable of performing fixation at a specified level which is separated upward Z1 from the upper-face portion 12 of the side sill 3, for example, it has a convex to engage with a concave or the like which is formed at the pillar reinforcement 5a.

### (Description of Opening Portion 17)

As shown in FIGS. 2, 3 and 6A, the present embodiment is configured such that the opening portion 17 which penetrates the upper-face portion 12 is formed at an inside portion 12a which is positioned at an inside of the space portion 16 at the upper-face portion 12 of the side sill 3.

The opening portion 17 of the present embodiment is an electrodeposition-liquid flowing hole though which an electrodeposition liquid A (see FIG. 5B) flows to the inside or outside of the side sill 3 (i.e., flow in or flow out).

The opening portion 17 as the electrodeposition-liquid flowing hole is constituted by plural holes which are separated from each other at the inside portion 12a at the upper-face portion 12 of the side sill 3. For example, as shown in FIG. 6A, three holes 17 are provided to be separated from each other in the vehicle longitudinal direction X at the inside portion 12a.

The electrodeposition liquid A is applied to the whole part of the vehicle body 1 for rust prevention (proof) after painting of the vehicle body 1 by a method that the vehicle body 1 is immersed in an electrolytic bath or the like. In a case where the electrodeposition liquid A is made to flow into the side sill 3 through the opening portion 17, as shown in FIG. 5A, the noise insulating plate 15 is fixed at a specified level from the inside portion 12a of the upper-face portion 12 of the side sill 3 between the pilar reinforcement 5a of the center pillar 5 and the vertical wall portion 14, and then, as shown in FIG. 5B, a gap 20 is previously formed between the noise insulating plate 15 and the vertical wall portion 14 by slightly inclining the noise insulating plate 15. The electrodeposition liquid A can be made to flow into the side sill 3 through this gap 20.

After the electrodeposition liquid A is applied to the whole part of the vehicle body 1, the vehicle body 1 is dried in a drier after the inclination of the noise insulating plate 15 is adjusted, thereby drying the electrodeposition liquid A. Herein, the sound absorbing material 15b of the noise insulating plate 15, which is made of the foaming material, comes to foam and expand, so that the gap between the noise insulating plate 15 and the pillar reinforcement 5a and the gap between the noise insulating plate 15 and the vertical wall portion 14 can be respectively closed.

Herein, an extra part of the electrodeposition liquid A can be discharged from the inside of the side sill 3 through the opening portion 17 before drying of the electrodeposition liquid A.

It is preferable that an opening ratio of an opening area of the opening portion 17 to an area of the inside portion 12a of the upper-face portion 12 is set to be larger than 0 or 0.2 or smaller in order to obtain the noise-insulation performance of the double wall constituted by the upper-face portion 12, the noise insulating plate 15 and the space portion 16.

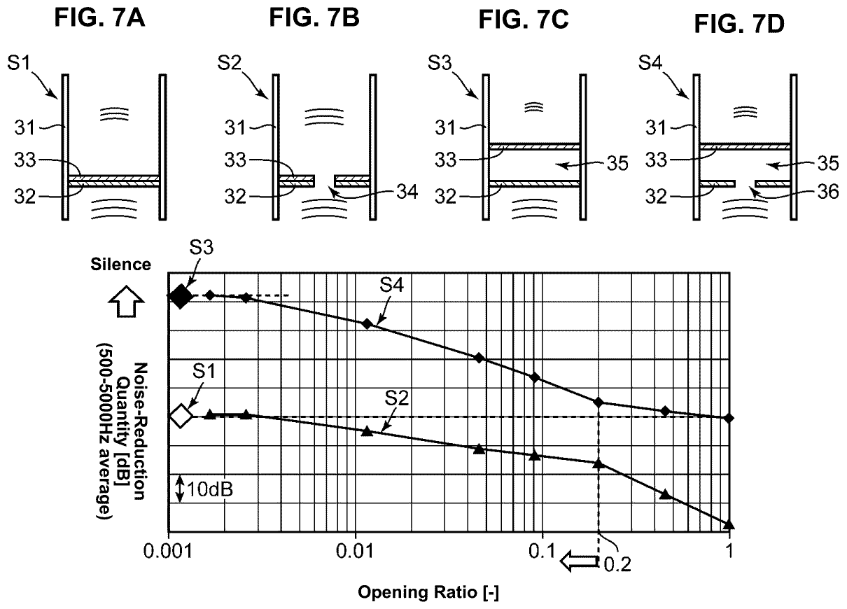

Herein, in order to verify a setting range of the above-described opening ratio, a relationship between the opening ratio and the noise-reduction quantity will be studied referring to FIGS. 7A-7D.

FIGS. 7A-7D are graphs showing a change of the noise-reduction quantity for the opening ratio regarding four types of structural models: FIG. 7A showing that regarding a single-layered structure with no hole S1; FIG. 7B showing that regarding a single-layered structure with a hole S2; FIG. 7C showing that regarding multiple-layered structure with no hole S3; and FIG. 7D showing that regarding multiple-layered structure with a hole S4.

Herein, the single-layered structure with no hole S1 is a structure in which a space inside a cylinder 31 is partitioned by a single-layered member which is formed by overlapping a first layer 32 and a second layer 33 which have the same material, thickness and mass. The single-layered structure with the hole S3 is a structure in which a penetration hole 34 is formed at the single-layered member formed by overlapping the first layer 32 and the second layer 33. The multiple-layered structure with no hole S3 is a structure in which the first layer 32 and the second layer 33 are separated from each other in an extension direction of the cylinder 31. The multiple-layered structure with the hole S4 is a structure in which a penetration hole 36 is formed at the first layer 32.

According to the graph of FIGS. 7A-7D, the single-layered structure with the hole S2 shows a characteristic that the smaller the opening ration of the penetration hole 34 is, the greater the noise-reduction quantity is. And, when the opening ratio becomes 0.2 or less, the grade of the noise-reduction quantity becomes great, so that the noise-reduction effect increases more, and finally reaches to the noise-reduction quantity of the single-layered structure with no hole S1.

Further, in the multiple-layered structure with the hole S4 as well, the noise-reduction quantity increases as the opening ratio of the penetration hole 36 penetrating the first layer 32 becomes smaller. However, when the opening ratio becomes 0.2 or less, the grade of the noise-reduction quantity becomes great more quickly compared to a case of the single-layered structure with the hole S2, so that the noise-reduction effect increases further and this noise-reduction quantity finally reaches to the noise-reduction quantity of the multiple-layered structure with no hole S3.

From results of the graph shown in FIGS. 7A-7D, it can be considered in the multiple-layered structure with the hole S4 that when the opening ratio becomes 0.2 or less, the noise-insulation performance of the double wall is exhibited, so that the noise-reduction effect increases further. This noise-insulation performance of the double wall is not exhibited in the single-layered structure with the hole S2.

Herein, it is preferable that the opening ratio of the opening portion 17 is set to be 0.003 or more for ensuring the flowing performance of the electrodeposition liquid A flowing to the inside or outside of the side sill 3 through the opening portion 17.

Further, it is preferable for improving the noise-insulation performance that a height ratio h/H of height h of the noise insulating plate 15 from the upper-face potion 12 of the side sill 3 to height H of an upper end of the vertical wall portion 14 from the upper-face portion 12 of the side sill 3 is set to be 0.2 or more or 1 or less, preferably 0.4 or more.

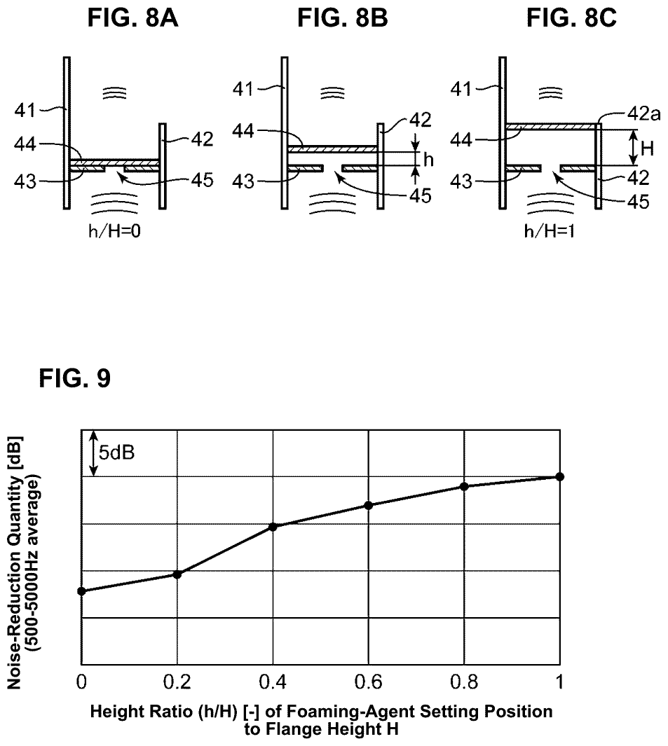

Herein, a relationship between the height ration and the noise-reduction quantity will be investigated referring to FIGS. 8A-8C and 9 in order to verify a setting range of the height ratio h/H of the above-described noise-reduction plate 15.

FIGS. 8A-8C schematically show models of the noise insulating plate 15 of the present embodiment in which height of this plate is changed, which comprise a first wall 41 which corresponds to the pillar reinforcement 5a, a second wall 42 having flange height H which corresponds to the vertical wall portion 14, a standard plate 43 having the opening portion 45 which corresponds to the inside portion 12a of the upper-face portion 12 of the side sill 3, and a foaming agent 44 which is separated upward from the standard plate 43 by height h. In FIGS. 8A-8C, states where the height h of the foaming agent 44 from the standard plate 43 is changed within a range of the flange height H, and specifically FIG. 8A shows a case of h=0, FIG. 8B shows a case of 0<h<H, and FIG. 8C shows a case of h=H. Herein, the flange height H shown in FIG. 8C is a distance between a lower face of the foaming agent 44 and an upper face of the standard plate 43 when the upper face of the foaming agene 44 is located at the same level of the upper end 42a of the second wall 42, i.e., the maximum height of a space between the standard plate 43 and the foaming agent 44.

FIG. 9 shows a graph showing a relationship between a height ratio h/H of the height h of the foaming agent 44 to the flange height H of the second wall 42 shown in FIG. 8C and the noise-reduction quantity.

It can be understood according to FIG. 9 that setting the height ratio h/H of 0.2 or more improves the grade of the noise-insulation quantity compared to a case where the height ratio h/H is less than 0.2. Accordingly, it can be considered that the noise-insulation performance can be improved securely by setting that the height ratio h/H is 0.2 or more.

Further, by setting that the height ratio h/H is 0.4 or more, the noise-insulation quantity exceeding a range where the grade of the noise-insulation quantity is large in a range of 0.2-0.4 is obtained, so that it can be considered that the noise-insulation performance is further improved.

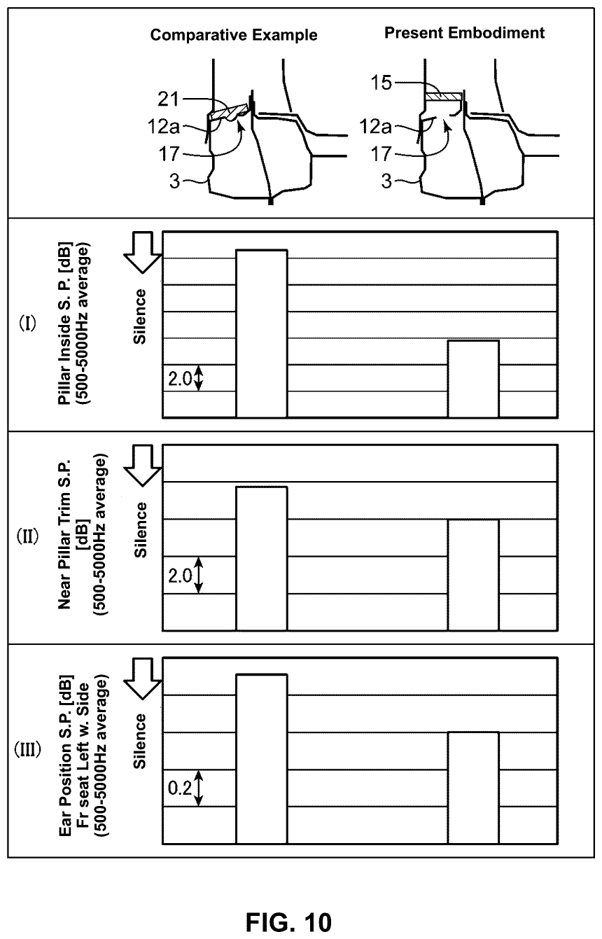

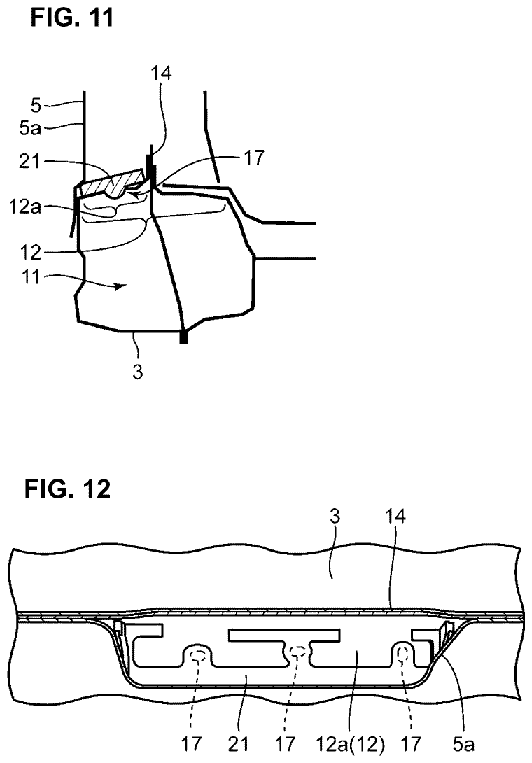

Next, the noise-insulation performance between the noise insulation structure of the present embodiment shown in FIG. 2 and a noise insulation structure of a comparative example shown in FIGS. 11 and 12 will be compared referring to graphs shown in FIG. 10.

The noise insulation structure of the comparative example shown in FIGS. 11 and 12 is a comparative one in which the foaming agent 21 directly closes the opening portion 17 of the inside portion 12a of the upper-face portion 12 of the side sill 3 (the one corresponding to the single-layered structure with no hole S1 shown in FIG. 7A). Specifically, as shown in FIG. 12, the foaming agent 21 closes the three opening portions 17 and an inner peripheral face of the pillar reinforcement 5a at a surface of the inside portion 12a of the upper-face portion of the side sill 3.

FIG. 10 shows bar graphs showing respective sound (noise) pressures in the noise insulation structure shown in FIG. 11 as the comparative example and the noise insulation structure of the present embodiment, in which (I) relates to a position of a pillar inside, (II) relates to a position near a pillar trim, and (III) relates to a position corresponding to an ear of a passenger in the vehicle (specifically, at a left-window side of a front seat).

Herein, the above-described position near the pillar trim is a position which is located near a pillar trim 22 which is positioned on the inward side Y2, in the vehicle width direction, of the vertical wall portion 14 shown in FIG. 6A.

It is apparent from the graphs of FIG. 10 that in all of the positions of (I) the pillar inside, (II) near the pillar trim, and (III) the ear of the passenger in the vehicle, the sound pressure of the noise insulation structure of the present embodiment decreases more greatly than the noise insulation structure of the comparative example.

### Features of Present Embodiment

(1)

The noise insulation structure of the vehicle frame of the present embodiment comprises the side sill 3 having the closed-cross section 11, the pillar reinforcement 5a having the lower-end portion 5c joined to the side sill 3 and the closed-cross section 13, the vertical wall portion 14 extending upward Z1 from the upper-face portion 12 of the side sill 3, and the noise insulating plate 15 provided to be separated upward Z1 from the upper-face portion 12 and forming the space portion 16 extending in the vertical direction Z together with the upper-face portion 12, the vertical direction 14, and the pillar reinforcement 5a. The opening portion 17 is formed at the inside portion 12a which is positioned inside the space portion 16 such that the opening portion 17 penetrates the upper-face portion 12.

The opening ratio of the opening area of the opening portion 17 to the area of the inside portion 12a of the upper-face portion 12 is set to be (more than 0) 0.2 or less.

According to the above-described structure, since the opening ratio of the opening portion 17 of the upper-face portion 12 of the side sill 3 is set to be 0.2 or less, the noise passing through the upper-face portion 12 of the side sill 3 becomes more dominant than the noise coming into the space portion 16 through the opening portion 17 regarding the traveling noise transmitted inside the side sill 3. Accordingly, the noise-insulation performance of the double wall can be sufficiently obtained by the noise insulating plate 15 and the upper-face portion 12 of the side sill 3. Therefore, the noise-insulation performance can be improved properly by providing the fewer noise insulating plates 15, forming the holes at the upper-face portion 12 of the side sill 3.

(2)

In the above-described noise insulation structure of the vehicle frame, the opening ratio is set to be 0.003 or more. Thereby, the electrodeposition liquid can be made to properly flow to the inside or the outside of the side sill 3 through the opening portion 17 in the vehicle manufacturing.

(3)

In the above-described noise insulation structure of the vehicle frame, the noise insulating plate 15 comprises the plate-shaped base material 15a and the sound absorbing material 15b, such as the foaming agent, which is arranged at the periphery of the base material 15a. The sound absorbing material 15b is configured to close the gap between the pillar reinforcement 5a and the base material 15a and the gap between the vertical wall portion 14 and the base material 15a. Thereby, the noise insulation can be attained securely.

(4)

In the above-described noise insulation structure of the vehicle frame, the opening portion 17 is the electrodeposition-liquid flowing hole, through which the electrodeposition liquid flows to the inside or outside of the side sill 3. The opening portion 17 as the electrodeposition-liquid flowing hole is constituted by plural holes which are formed at the inside portion 12a of the upper face portion 12 such that the plural holes are separated from each other. According to this structure, the electrodeposition liquid, such as the rust preventive agent, can be made to properly flow to the inside or the outside of the side sill 3 through the opening portion 17.

(5)

In the above-described noise insulation structure of the vehicle frame, the height ratio h/H of the height of the noise insulating plate 15 from the upper face 12 of the side sill 3 to the height of the upper end of the vertical wall portion 14 from the upper face 12 of the side sill 3 is set to be 0.2 or more or 1 or less. Accordingly, the grade of the noise-insulation quantity can be improved more than a case where the height ratio h/H is less than 0.2, thereby improving the noise-insulation performance securely.

(6)

In the above-described noise insulation structure of the vehicle frame, the height ratio h/H is set to be 0.4 or more. According to this structure, the noise-insulation quantity which exceeds a range of the high grade of the noise-insulation quantity in a case where the height ratio h/H is 0.2-0.4 can be obtained, thereby improving the noise-insulation performance more.

(7)

In the above-described noise insulation structure of the vehicle frame, the side sill 3 comprises the side sill outer 3a and the side sill inner 3b positioned on the inward side Y2, in the vehicle width direction, of the side sill outer 3a. Each of the side sill outer 3a and the side sill inner 3b extends in the vehicle longitudinal direction X and has the hat-shaped cross section with the pair of flange portions 3a1, 3b1, 3a2, 3b2 provided at each upper-end portion and lower-end portion. The side sill 3 is formed by joining the respective flange portions 3a1, 3b1, 3a2, 3b2 of the side sill outer 3a and the side sill inner 3b. The vertical wall portion 14 is formed by the flange portions 3a1, 3b1 upward protruding of the side sill outer 3a and the side sill inner 3b.

According to this structure, the conventional side sill 3 comprising the side sill outer 3a and the side sill inner 3b which have the hat-shaped cross section, respectively, is applicable. Therefore, this noise-insulation structure can have the high versatility and low manufacturing costs.

### MODIFICATION

### (A)

The above-described embodiment shows an example of the vertical wall 14 extending upward from the side sill 3, which is constituted by the upward-protruding flange portions 3a1, 3b1 at the side sill outer 3a and the side sill inner 3b which have the hat-shaped cross section, respectively. The present invention, however, is not limited to this, and any vertical wall portion is applicable as long as it extends upward. For example, the present invention includes an embodiment in which the vertical wall portion extending upward is attached to the upper-face portion of the side sill having the closed-cross section by welding or the like, or the vertical wall portion is integrally formed at the side sill.

### (B)

While the opening portion 17 is exemplified as one example of the electrodeposition-liquid flowing hole in the above-described embodiment, the present invention is not limited to this. Any opening portion is applicable as long as it is formed at the inside portion of the space portion between the pillar reinforcement and the vertical wall portion. For example, any hole for passing an electric cable therethrough or the like are included in the present invention.

### (C)

While the pillar reinforcement 5a of the center pillar 5 is shown in the above-described embodiment as an example of the pillar reinforcement, the present invention is not limited to this. Any pillar reinforcement of the front pillar or the rear pillar is applicable as long as it is joined to the side sill and has a closed-cross section extending upward from the side sill.

What is claimed is:

1. A noise insulation structure of a vehicle frame, comprising:
a side sill arranged at a vehicle outside-end portion of a cabin floor portion of a vehicle and having a closed-cross section extending in a vehicle longitudinal direction and an upper-face portion forming an upper face of the closed-cross section;
a pillar reinforcement having a lower-end portion joined to the side sill and a closed-cross section extending in a vertical direction above the upper-face portion of the side sill;
a vertical wall portion extending upward from the upper-face portion of the side sill; and
a noise insulating plate provided to be separated upward from the upper-face portion of the side sill and forming a space portion extending in the vertical direction together with the upper-face portion of the side sill, the vertical wall portion, and the pillar reinforcement,
wherein an opening portion is formed at an inside portion of said upper-face portion of the side sill which is positioned inside said space portion such that said opening portion penetrates said upper-face portion, and an opening ratio of an opening area of said opening portion to an area of said inside portion of the upper-face portion is set to be 0.2 or less.

2. The noise insulation structure of the vehicle frame of claim 1, wherein said opening ratio is set to be 0.003 or more.

3. The noise insulation structure of the vehicle frame of claim 2, wherein said noise insulating plate comprises a plate-shaped base material and a sound absorbing material arranged at a periphery of said base material and having a sound-absorption performance, and said sound absorbing material is configured to close a gap between said pillar reinforcement and said base material of the noise insulating plate and a gap between said vertical wall portion and said base material of the noise insulating plate.

4. The noise insulation structure of the vehicle frame of claim 3, wherein said opening portion is an electrodeposition-liquid flowing hole, through which an electrodeposition liquid flows to an inside or outside of said side sill, and said electrodeposition-liquid flowing hole is constituted by plural holes which are formed at said inside portion of the upper face portion of the side sill such that the plural holes are separated from each other.

5. The noise insulation structure of the vehicle frame of claim 4, wherein a height ratio of height of said noise insulating plate from said upper face of the side sill to height of an upper end of said vertical wall portion from the upper face of the side sill is set to be 0.2 or more or 1 or less.

6. The noise insulation structure of the vehicle frame of claim 5, wherein said height ratio is set to be 0.4 or more.

7. The noise insulation structure of the vehicle frame of claim 6, wherein said side sill comprises a side sill outer and a side sill inner positioned on an inward side, in a vehicle width direction, of said side sill outer, each of said side sill outer and said side sill inner extends in the vehicle longitudinal direction and has a hat-shaped cross section with a pair of flange portions provided at each upper-end portion and lower-end portion, said side sill is formed by joining said respective flange portions of the side sill outer and the side sill inner, and said vertical wall portion is formed by said flange portions upward protruding of said side sill outer and said side sill inner.

8. The noise insulation structure of the vehicle frame of claim 1, wherein said noise insulating plate comprises a plate-shaped base material and a sound absorbing material arranged at a periphery of said base material and having a sound-absorption performance, and said sound absorbing material is configured to close a gap between said pillar reinforcement and said base material of the noise insulating plate and a gap between said vertical wall portion and said base material of the noise insulating plate.

9. The noise insulation structure of the vehicle frame of claim 1, wherein said opening portion is an electrodeposition-liquid flowing hole, through which an electrodeposition liquid flows to an inside or outside of said side sill, and said electrodeposition-liquid flowing hole is constituted by plural holes which are formed at said inside portion of the upper face portion of the side sill such that the plural holes are separated from each other.

10. The noise insulation structure of the vehicle frame of claim 1, wherein a height ratio of height of said noise insulating plate from said upper face of the side sill to height of an upper end of said vertical wall portion from the upper face of the side sill is set to be 0.2 or more or 1 or less.

11. The noise insulation structure of the vehicle frame of claim 1, wherein said side sill comprises a side sill outer and a side sill inner positioned on an inward side, in a vehicle width direction, of said side sill outer, each of said side sill outer and said side sill inner extends in the vehicle longitudinal direction and has a hat-shaped cross section with a pair of flange portions provided at each upper-end portion and lower-end portion, said side sill is formed by joining said respective flange portions of the side sill outer and the side sill inner, and said vertical wall portion is formed by said flange portions upward protruding of said side sill outer and said side sill inner.

12. The noise insulation structure of the vehicle frame of claim 2, wherein a height ratio of height of said noise insulating plate from said upper face of the side sill to height of an upper end of said vertical wall portion from the upper face of the side sill is set to be 0.2 or more or 1 or less.

13. The noise insulation structure of the vehicle frame of claim 2, wherein said side sill comprises a side sill outer and a side sill inner positioned on an inward side, in a vehicle width direction, of said side sill outer, each of said side sill outer and said side sill inner extends in the vehicle longitudinal direction and has a hat-shaped cross section with a pair of flange portions provided at each upper-end portion and lower-end portion, said side sill is formed by joining said respective flange portions of the side sill outer and the side sill inner, and said vertical wall portion is formed by said flange portions upward protruding of said side sill outer and said side sill inner.

14. The noise insulation structure of the vehicle frame of claim 8, wherein a height ratio of height of said noise insulating plate from said upper face of the side sill to height of an upper end of said vertical wall portion from the upper face of the side sill is set to be 0.2 or more or 1 or less.

15. The noise insulation structure of the vehicle frame of claim 8, wherein said side sill comprises a side sill outer and a side sill inner positioned on an inward side, in a vehicle width direction, of said side sill outer, each of said side sill outer and said side sill inner extends in the vehicle longitudinal direction and has a hat-shaped cross section with a pair of flange portions provided at each upper-end portion and lower-end portion, said side sill is formed by joining said respective flange portions of the side sill outer and the side sill inner, and said vertical wall portion is formed by said flange portions upward protruding of said side sill outer and said side sill inner.

16. The noise insulation structure of the vehicle frame of claim 9, wherein a height ratio of height of said noise insulating plate from said upper face of the side sill to height of an upper end of said vertical wall portion from the upper face of the side sill is set to be 0.2 or more or 1 or less.

17. The noise insulation structure of the vehicle frame of claim 9, wherein said side sill comprises a side sill outer and a side sill inner positioned on an inward side, in a vehicle width direction, of said side sill outer, each of said side sill outer and said side sill inner extends in the vehicle longitudinal direction and has a hat-shaped cross section with a pair of flange portions provided at each upper-end portion and lower-end portion, said side sill is formed by joining said respective flange portions of the side sill outer and the side sill inner, and said vertical wall portion is formed by said flange portions upward protruding of said side sill outer and said side sill inner.

18. The noise insulation structure of the vehicle frame of claim 10, wherein said height ratio is set to be 0.4 or more.

19. The noise insulation structure of the vehicle frame of claim 12, wherein said height ratio is set to be 0.4 or more.

20. The noise insulation structure of the vehicle frame of claim 13, wherein said height ratio is set to be 0.4 or more.
